(19) United States
(12) Patent Application Publication
(10) Pub. No.: US 2009/0316673 A1
(43) Pub. Date: Dec. 24, 2009

(54) VEHICULAR COMMUNICATION GATEWAY

(76) Inventors: MARTIN G. YAGLEY, Sterling Heights, MI (US); Edward R. Griffor, Grosse Pointe Park, MI (US); John A. Wilke, Wichita Falls, TX (US); Neil L. Borkowicz, Plymouth, MI (US)

Correspondence Address: Ralph E Smith, CIMS 483-02-19;Chrysler LLC, 800 Chrysler Drive East, Auburn Hills, MI, 48326-2757, US

(21) Appl. No.: 12/487,646

(22) Filed: Jun. 18, 2009

Related U.S. Application Data
(60) Provisional application No. 61/073,386, filed on Jun. 18, 2008.

(51) Int. Cl. H04W 88/16; H04B 7/00

(52) U.S. Cl. 370/338; 455/66.1

(57) ABSTRACT

A system for enabling secure access to an in-vehicle gateway module includes a mobile wireless transceiver on the vehicle in communication with the gateway module, and at least one stationary wireless transceiver in communication with a home computer system, for example, as part of the vehicle owner's home network, or via an internet connection to the home network. The home computer system authenticates all data transfer to and from the vehicle gateway module while preferably also providing a “server” or information consolidation function.

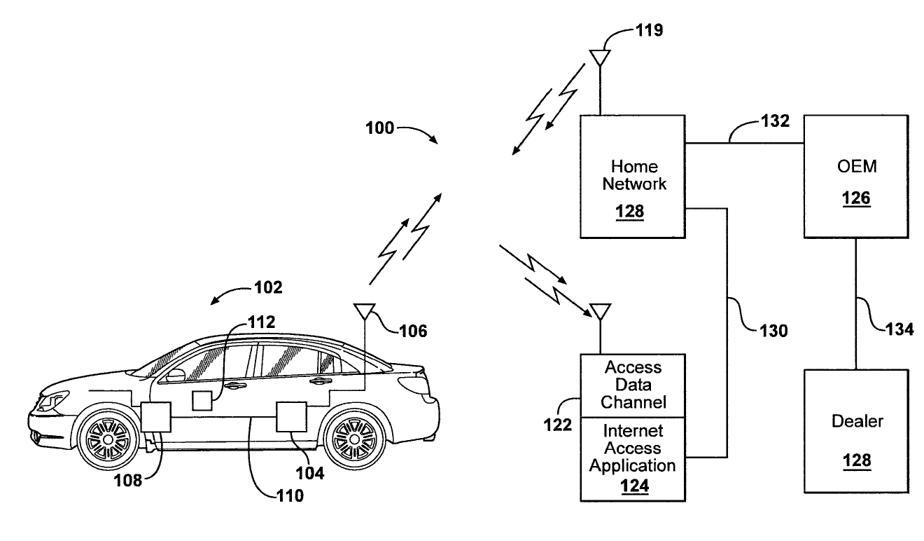

### CROSS REFERENCE TO RELATED APPLICATIONS

This application claims the benefit of U.S. Provisional Patent Application Ser. No. 61/073,386 filed Jun. 18, 2008, the disclosure of which is hereby incorporated by reference.

### BACKGROUND OF THE INVENTION

The invention relates to computerized modules for vehicles which enable secure access to the vehicle modules from at least one of a vehicle user's home computer network, a computer system of the manufacturer of the vehicle (OEM), and third-party service providers.

### SUMMARY OF THE INVENTION

A system for enabling secure access to an in-vehicle gateway module includes a first wireless transceiver on the vehicle in communication with the gateway module, and a second wireless transceiver in communication with a home computer system, for example, on the vehicle owner's/vehicle user's home network which provides a “server” or information consolidation function. When the vehicle is in-range of the second transceiver, the in-vehicle module forms a part of a vehicle user's home computer network via the resulting wireless link and thereafter serves as a gateway from the user's home network to the vehicle.

The system further includes a software package on the user's home computer system forming a vehicle application interface and manager with which to authenticate the relationship between the vehicle gateway module and the home computer system. The software package further serves to manage communication between the vehicle and other systems/networks, for example, via an internet connection. By way of further example only, the other systems/networks may include a system owned or operated by the vehicle's manufacturer (OEM), for example, to provide/flash updated vehicle controller programming or to collect vehicle operating data for statistical analysis; or a system owned or operated by the user's preferred vehicle dealer; or a system owned or operated by a user-authorized third party, such as a source of digital music downloads for an onboard infotainment system. And, in accordance with another aspect of the invention, the system preferably also includes a complementary software application running on a computer system of the original equipment manufacturer (OEM) of the vehicle and/or on a computer system of a vehicle dealership or other service organization. Thus, in accordance with the invention, the system manages the legal relationship between the vehicle and these other systems/networks, to thereby give the vehicle owner or user complete and secure control over the access granted to such other systems/networks.

In accordance with another aspect of the invention, the vehicle's wireless transceiver may also connect to the home computer system through one of a plurality of other transceivers defining an alternative data channel to the home computer system, for example, via the internet. Once again, the software package on the home computer system validates and confirms any device interfacing with the vehicle gateway module to thereby ensure that only authorized data transfer occurs between the vehicle and another system or network.

In accordance with yet another aspect of the invention, the vehicle gateway module is also capable of communicating via other available wireless channels for acting on various executive functions within the vehicle, as when sending or receiving information to an operator's key fob, PDA, cell phone, or the like.

Other objects, features, and advantages of the present invention will be readily appreciated upon a review of the subsequent description of the preferred embodiment and the appended claims, taken in conjunction with the accompanying Drawings.

### BRIEF DESCRIPTION OF THE DRAWING

The Drawing is a functional schematic of a vehicular gateway and communication system arranged in accordance with the invention.

### DETAILED DESCRIPTION OF THE PREFERRED EMBODIMENT

Referring to Drawing, a communication system 100 for a vehicle 102 includes a gateway module 104, which is coupled to other relevant vehicle control module(s) 108 via a standard vehicle data bus 110. The vehicle control modules 108 may include vehicle controllers such as a driver preference controller (by which to set such driver preferences as seating, steering wheel, and remote mirror positions, driving style preferences, and the like), as well as vehicle system controllers such as a powertrain controller (from which to obtain, for example, information regarding the operation of the vehicle's powertrain).

The system 100 also includes a first wireless transceiver, such as an RF transceiver 106, on the vehicle 102, and a second wireless transceiver 119 that forms a part of a vehicle user's home network. The home transceiver 119 is in communication with a home computer system 120 on the home network. While the preferred embodiment shown in the Drawing employs RF signals, it will be appreciated that the invention contemplates use of any suitable wireless communication channel or carrier whose signal can be modulated to transmit/receive encoded information between the vehicle gateway module 104 and the home computer system 120. By way of further example only, where local laws limit such wireless communication to line-of-sight, the system's wireless transceivers may utilize IR signals to communicate with one another. In accordance with an aspect of the invention, when the vehicle's transceiver 106 comes into range of the home transceiver 119 and its identity is authenticated, the vehicle gateway module 104 effectively becomes a part of the home network.

Returning to the Drawing, the vehicle gateway module 104 can also communicate with the home computer system 120 via alternative data channel 122 which itself includes a third transceiver and a computer running an internet access application 124 for coupling gateway 104 to home system 120 via the internet, as represented by connection 130.

Once communications are authenticated by the home computer system 120, the OEM computer system 126 and/or a dealership or other service organization 128 can communicate with the vehicle gateway module 104 via internet connections 132, 134 and the home computer system 120. Most preferably, the OEM and service provider can only communicate with vehicle gateway 104 via secure access enabled only via the user's home system 120.

Exemplary applications for the disclosed system are, as follows:
The Vehicle as a Home Network Component
Vehicle module: Communications Node
   Home PC SW Package: Vehicle Manager
   Applications:
      1. Manage and download audio playlist
      2. Manage auto settings (audio, hvac, usw)
      3. Easy Bluetooth device synch
      4. Vehicle tracking (requires GPS)
      5. Cell phones present (could include cell phone, WiFi or Satellite communication)
      6. Integrated VOIP or SKYPE calling to in car cells
      7. Automatic garage door open/close
      8. Optional vehicle prep (climate control and memory settings; set for time or timing profile)
      9. Vehicle diagnostics summary
      10. OEM diagnostic analysis
      11. Dealer service prompting and scheduling
      12. Auto service diagnostics download to dealer
      13. Auto Map Updates (Navigation)
      14. Module SW Release downloads
      15. Auto Bluetooth Home Compatibility (across vehicle and home apps)
      16. Optional Biometric Key Lock (preventing access of other people with key)
      17. “Car Ready By” (time, with ‘OK to Start’ option)
      18. “Lock Until” (no acceptable opening during trips, overnight, etc)
      19. Intrusion Reporting through available networks (with auto police notification option)
Predictive Driver Vehicle Preparation (Passive Driver Profile generation based on key used)
   1. Seat Position
   2. HVAC setting based on temperature measurements
   3. Heated/vented seat
   4. Audio presets
   5. Audio Playlist or menu customization
   6. Shift schedule and active suspension profile
Quick Bluetooth matching with RFID technology
Key Finder (credit car-sized module for emergencies)
Power-line data communication
Noise canceling Bluetooth phone headset
Steering wheel feedback for lane encroachment (‘ice-ball’ technology)
Light-sensitive Solar Cells (in-glass, to assist with HVAC power)
Biometric verification for PEKG (true keyless operation)
Garmin Navigation engine (MCM and performance improvement)

While the above description constitutes the preferred embodiment, it will be appreciated that the invention is susceptible to modification, variation and change without departing from the proper scope and fair meaning of the subjoined claims.

What is claimed is:

1. A system for controlling a data transfer between a gateway module on a vehicle and a remote system, comprising:
a mobile wireless transceiver on the vehicle in communication with the vehicle gateway module;
a stationary network having a computer system and a first stationary wireless transceiver in communication with the computer system, wherein the computer system authenticates the identity of the vehicle gateway module and the remote system prior to transferring the data between the gateway module.

2. The system of claim 1, wherein the computer system is connected to the remote system by the internet.

3. The system of claim 1, further including a second wireless transceiver in communication with the computer system over the internet.

4. The system of claim 1, wherein the first and second transceivers are RF transceivers.
